(19) United States
(12) Patent Application Publication
(10) Pub. No.: US 2025/0370449 A1
(43) Pub. Date: Dec. 4, 2025

(54) PREVENTIVE MAINTENANCE SUPPORT SYSTEM AND PREVENTIVE MAINTENANCE SUPPORT METHOD

(71) Applicant: Hitachi Vantara, Ltd., Kanagawa-ken (JP)

(72) Inventor: Yoshihiko Hosobuchi, Kanagawa-ken (JP)

(21) Appl. No.: 19/064,606

(22) Filed: Feb. 26, 2025

(30) Foreign Application Priority Data
May 30, 2024 (JP) 2024-088130

(51) Int. Cl. G05B 23/02

(52) U.S. Cl. CPC G05B 23/0283; G05B 23/0264

(57) ABSTRACT

A preventive maintenance support system according to one aspect of the present invention is a preventive maintenance support system in which a calculator including an arithmetic apparatus that executes a program and a storage device that stores the program executes processing of supporting preventive maintenance on a monitoring target apparatus. The arithmetic apparatus acquires log information of a device mounted on the monitoring target apparatus, specifies a device to be subjected to preventive replacement based on information indicating a state of the device included in the log information and a reference value of a failure sign determined according to a redundancy of the device and an importance level of the device, and presents the device to the operation terminal.

### BACKGROUND

### Technical Field

The present invention relates to a preventive maintenance support system and a preventive maintenance support method for supporting preventive maintenance based on failure sign detection in a monitoring target apparatus.

### Related Art

Conventionally, information technology (IT) systems responsible for social infrastructure are required to continue to operate normally. With the recent trend toward cloud computing, there has been a shift to on-premises regression in which important data is managed within sight by having own assets or subscribing to private cloud services.

It has been a conventional idea that maintenance is performed after a server or a storage constituting an IT system is broken. However, an idea of preventing business stoppage in advance by performing preliminary replacement (preventive maintenance) based on failure sign detection even though an additional cost is paid is also becoming common.

However, to perform the preventive replacement based on failure sign detection, it is necessary to investment in the backup hardware resource for backup. For example, the maintenance time is often a holiday or late night so as not to affect the IT system. It is necessary to prepare a system dedicated to maintenance for the work of the specially set maintenance time. Typically, such preventative maintenance is not covered by a maintenance service agreement. In a current IT system, various individual systems are combined or linked, and thus a propagation range of one failure is increased. In addition, currently, a decrease in the labor population and aging are also progressing. These elements make it difficult to prepare a system dedicated to maintenance.

When the maintenance plan is considered, the priority and how much cost is to be applied vary depending on the importance level and redundancy of each individual system and apparatus constituting the IT system.

For example, information such as a level of importance of a suspicious part (an apparatus or the like in which a failure is predicted) and an influence range due to the failure of the suspicious part based on the configuration of the IT system is not stored in the database. Thus, when there are a plurality of suspicious parts, the priority of each suspicious part is not defined.

In addition, in the maintenance based on failure sign detection, it is not always necessary to replace the suspicious part. It is also reasonable to consider influence reduction (backup of application software operating on the suspected part or load distribution to other devices) in consideration of optimization of system operation.

When the suspicious part (hardware) is replaced, the apparatus may be stopped, and it is necessary to switch the IT system to the standby system before the apparatus is stopped. Depending on the structure of the IT system, the software used in the system, or the like, there is a case where stopping processing for instantaneous interruption or a certain period of time to perform switching is a premise of backup. Since man-hours such as man-hours for switching work and man-hours for making known to related systems and users occur, the cost efficiency deteriorates when the number of times of backup of the application software increases to perform the preventive maintenance. Thus, there is a need to provide risk hedging options for the risk of failure.

For example, Patent Literature 1 describes that “Information defining the configuration of an entity or an O&M asset is registered in an entity O&M asset definition DB. Information defining a system belonging to an O&M asset is registered in an O&M asset system definition DB” and “Schedule of predictive maintenance can be planned reflecting the convenience of O&M assets and maintenance entities”.

### CITATION LIST

### Patent Literature

Patent Literature 1: JP 2019-133412 A

### SUMMARY

However, in the preventive maintenance, apart from normal maintenance (maintenance and replacement triggered by component failure), a component is inspected and replaced before failure, and thus costs such as a component cost and an inspection work cost are required. Since the preventive maintenance requires an additional cost in addition to the cost required for normal maintenance, the more the preventive maintenance is performed, the more the cost increases. This also leads to an increase in the risk of replacing a component that can still sufficiently continue operation with a new component.

In view of the above circumstances, there has been a demand for a method for optimizing the cost performance at the time of performing preventive maintenance.

To solve the above problem, a preventive maintenance support system according to one aspect of the present invention is a preventive maintenance support system in which a calculator including an arithmetic apparatus that executes a program and a storage device that stores the program executes processing of supporting preventive maintenance on a monitoring target apparatus.

The arithmetic apparatus acquires log information of a device mounted on the monitoring target apparatus, specifies a device to be subjected to preventive replacement based on information indicating a state of the device included in the log information and a reference value of a failure sign determined according to a redundancy of the device and an importance level of the device, and presents the device to the operation terminal.

According to at least one aspect of the present invention, the arithmetic apparatus identifies the device to be subjected to preventive replacement and presents the device to the operation terminal, and thus the cost performance at the time of performing preventive maintenance can be optimized.

Problems, configurations, and effects other than those described above will be clarified by the following description of modes for carrying out the invention.

### BRIEF DESCRIPTION OF DRAWINGS

FIG. 1 is a diagram illustrating an example of a configuration of an entire preventive maintenance support system according to an embodiment of the present invention;

FIG. 2 is a diagram illustrating a hardware configuration example of each processing unit configuring the preventive maintenance support system according to an embodiment of the present invention;

FIG. 3 is a flowchart illustrating an example of a procedure of preventive maintenance support processing with the preventive maintenance support system according to an embodiment of the present invention;

FIG. 4 is a diagram illustrating an example of a hardware configuration of a monitoring target apparatus according to an embodiment of the present invention;

FIG. 5 is a diagram illustrating an example of configuration information regarding path redundancy of the devices mounted on the monitoring target apparatus according to an embodiment of the present invention;

FIG. 6 is a diagram illustrating an example of configuration information regarding business importance level of the devices mounted on the monitoring target apparatus according to an embodiment of the present invention;

FIG. 7 is a diagram illustrating an example of search target data (search target item) for each device included in the monitoring target apparatus according to an embodiment of the present invention;

FIG. 8 is a diagram illustrating an example of a threshold used for failure sign detection on a monitoring target apparatus according to an embodiment of the present invention;

FIG. 9 is a diagram illustrating a concept of a light amount threshold of SFP in the preventive maintenance support system according to an embodiment of the present invention;

FIG. 10 is a diagram illustrating an example of failure sign detection with the preventive maintenance support system according to an embodiment of the present invention; and

FIG. 11 is a diagram illustrating a specific example of an IT system to which the preventive maintenance support system according to an embodiment of the present invention is applied.

### DETAILED DESCRIPTION

Hereinafter, examples of modes for carrying out the present invention (hereinafter, referred to as “embodiments”) will be described with reference to the accompanying drawings.

In the present specification and the accompanying drawings, the same components or similar components are denoted by the same reference numerals, and redundant description may be omitted, or only description focusing on a difference may be made. When there is a plurality of the same or similar components, the same reference numerals may be attached with different subscripts for description. When it is not necessary to distinguish the plurality of components, the subscripts may be omitted. The number of each component may be singular or plural unless otherwise specified. Expressions such as “part”, “component”, and “device” are used as elements constituting the monitoring target apparatus, and these expressions are interchangeable.

In the example of the following embodiment, various types of information will be described in a table format, but the various types of information may be in a data format other than the table format. In addition, for example, various names such as “XX information”, “XX table”, “XX list”, and “XX chart” are interchangeable.

### One Embodiment

### [Overall Configuration of Preventive Maintenance Support System]

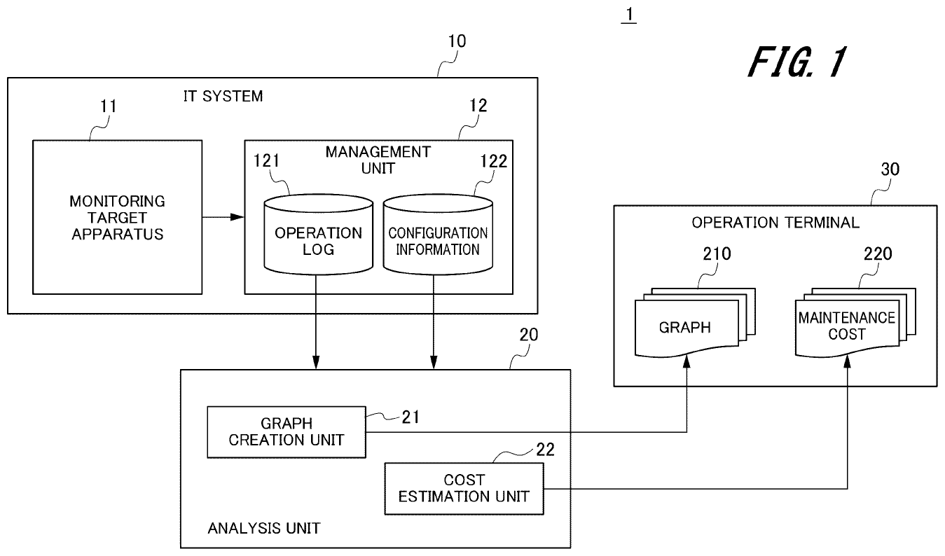

First, a configuration of an entire preventive maintenance support system according to an embodiment of the present invention will be described with reference to FIG. 1.

FIG. 1 is a diagram illustrating an example of a configuration of an entire preventive maintenance support system according to an embodiment of the present invention.

A preventive maintenance support system 1 is roughly divided into an IT system 10, an analysis unit 20, and an operation terminal 30.

The IT system 10 is a system including a monitoring target apparatus 11 and a management unit 12.

The monitoring target apparatus 11 is an apparatus or system to be subjected to failure sign detection.

The management unit 12 is a processing unit (arithmetic apparatus) that collects and manages data related to the monitoring target apparatus 11. The management unit 12 collects data at the time of operation of each part of the monitoring target apparatus 11 periodically or at a predetermined timing and holds the data as a log file (operation log 121). The management unit 12 manages information (configuration information 122) related to the configuration of the monitoring target apparatus 11.

The analysis unit 20 is a processing unit (arithmetic apparatus) that acquires data (operation log 121) at the time of operation of each part of the monitoring target apparatus 11 provided from the management unit 12 and analyzes the data.

The analysis unit 20 includes a graph creation unit 21 and a cost estimation unit 22.

The graph creation unit 21 has a function of analyzing the operation log 121 acquired from the monitoring target apparatus 11 and creating a graph 210 based on the analysis result.

The cost estimation unit 22 calculates the cost of the preventive maintenance (maintenance cost 220) for the monitoring target apparatus 11 based on the analysis result (analysis data) on the operation log 121 from the graph creation unit 21. That is, the cost estimation unit 22 has a function of calculating a cost at the time of performing the preventive replacement of the device to be subjected to the preventive replacement in advance and presenting the cost to the operation terminal 30.

The operation terminal 30 is a device having a display function that enables an operator to refer to information (graph 210, maintenance cost 220) processed by the analysis unit 20.

The IT system 10, the analysis unit 20, and the operation terminal 30 can communicate with each other via a communication network. The management unit 12 communicates with the monitoring target apparatus 11 via a communication network or a dedicated line. Although an example in which the IT system 10 is configured by the monitoring target apparatus 11 and the management unit 12 has been described, the management unit 12 does not have to be included in the IT system 10.

### [Hardware Configuration of Each Apparatus of Preventive Maintenance Support System]

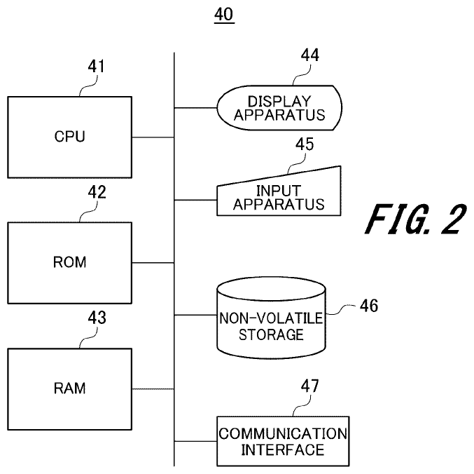

Next, a hardware configuration of each apparatus constituting the preventive maintenance support system 1 will be described with reference to FIG. 2.

FIG. 2 is a diagram illustrating a hardware configuration example of each apparatus configuring the preventive maintenance support system 1. The monitoring target apparatus 11, the management unit 12, the analysis unit 20, and the operation terminal 30 correspond to the respective apparatuses constituting the preventive maintenance support system 1. A calculator 40 illustrated in FIG. 2 is an example of hardware used as a computer. Each apparatus constituting the preventive maintenance support system 1 realizes preventive maintenance support performed by the apparatuses illustrated in FIG. 1 in cooperation with each other with the calculator 40 (computer) executing a program.

The calculator 40 includes a central processing unit (CPU) 41, a read only memory (ROM) 42, and a random access memory (RAM) 43 connected to a system bus.

The calculator 40 further includes a display apparatus 44, an input apparatus 45, a non-volatile storage 46, and a communication interface 47.

The CPU 41 reads a program code of software for realizing each function according to the present embodiment from the ROM 42, loads the program code into the RAM 43, and executes the program code. Variables, parameters, and the like generated during arithmetic processing of the CPU 41 are temporarily written to the RAM 43, and these variables, parameters, and the like are appropriately read by the CPU 41. Functions of the apparatuses and the terminals of the preventive maintenance support system 1 are realized by the CPU 41 executing the program code read from the ROM 42. However, another processor such as a micro processing unit (MPU) may be used instead of the CPU 41.

The non-volatile storage 46 is an example of a recording medium, which can store data used by a program, data obtained by executing the program, and the like. For example, the non-volatile storage 46 stores an introduction candidate facility list 1000, an introduction area/introduction facility list, evaluation results thereof and the like. A part or all of various types of data (information) illustrated in FIG. 1 may be stored in the non-volatile storage 46. An operating system (OS) or a program to be executed by the CPU 41 may be recorded in the non-volatile storage 46. As the non-volatile storage 46, a hard disk drive (HDD), a solid state drive (SSD), a disk medium using light or magnetism, a semiconductor memory card, or the like is used.

As the communication interface 47, a communication device such as a network interface card (NIC) is used, for example. The communication interface 47 can transmit and receive various type of data to and from an external apparatus via a communication network such as a connected LAN, a dedicated line, or the like. Various types of information (data) are input to each apparatus and terminal of the preventive maintenance support system 1 by using the communication interface 47.

The display apparatus 44 is a monitor such as a liquid crystal display, which displays a graphical user interface (GUI) screen, a result of arithmetic processing performed by the CPU 41, and the like. The input apparatus 45 generates an input signal according to a user's operation and outputs the input signal to the CPU 41. As the input apparatus 45, for example, a mouse, a keyboard, a touch sensor, or the like is used, and the user can input information and instructions by operating the input apparatus 45. The display apparatus 44 and the input apparatus 45 may be integrally configured as a touch panel.

### [Procedure of Preventive Maintenance Support Processing]

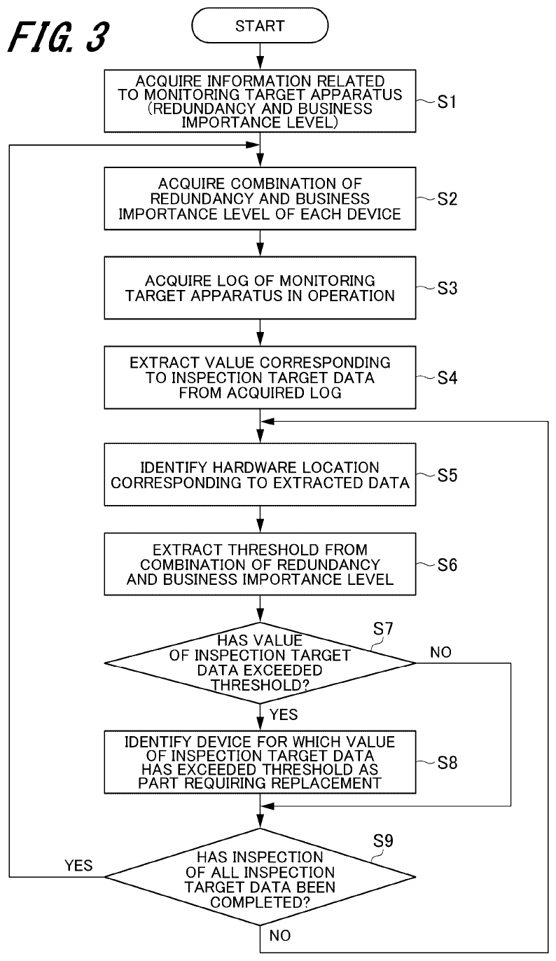

Next, the preventive maintenance support processing with the preventive maintenance support system 1 will be described with reference to FIG. 3.

FIG. 3 is a flowchart illustrating an example of the procedure of the preventive maintenance support processing with the preventive maintenance support system 1.

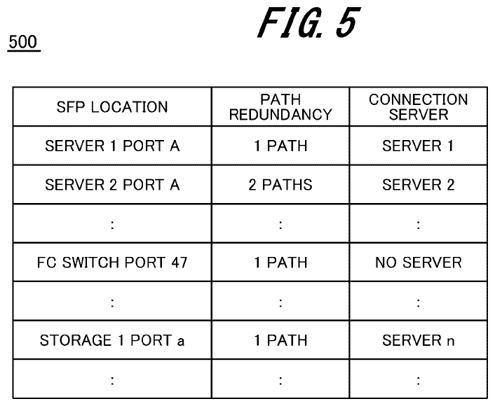

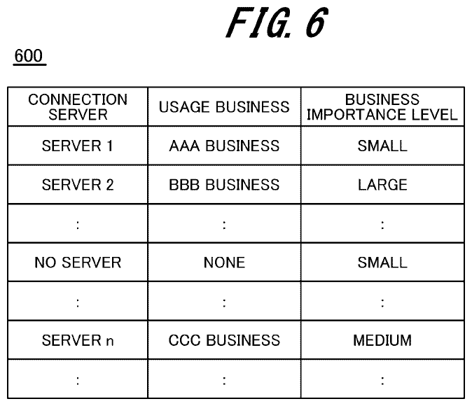

First, the analysis unit 20 of the preventive maintenance support system 1 acquires information related to the monitoring target apparatus 11 of the IT system 10 (step S1). The information related to the monitoring target apparatus 11 includes configuration information related to the redundancy of the devices constituting the monitoring target apparatus 11 (see FIG. 5 to be described later) and configuration information related to the business importance level (see FIG. 6 to be described later). As an example, the processing of step S1 is performed at the timing when the analysis unit 20, which is a main function of the preventive maintenance support system 1, is delivered to the IT system 10.

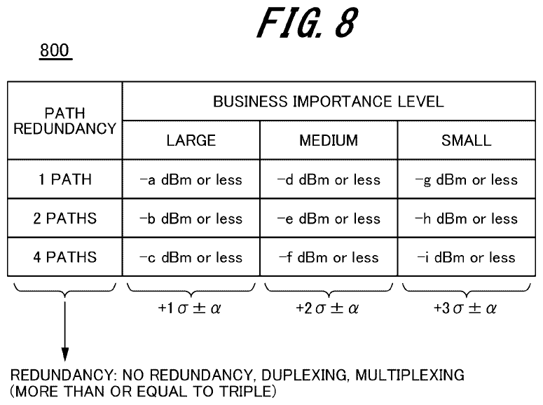

Next, the analysis unit 20 acquires a combination of the redundancy and the business importance level of each device constituting the monitoring target apparatus 11 (see FIG. 8 to be described later) (step S2).

Next, the analysis unit 20 acquires the operation log 121 of the monitoring target apparatus 11 in operation from the management unit 12 (step S3). In the following description, the operation log may be abbreviated as “log”.

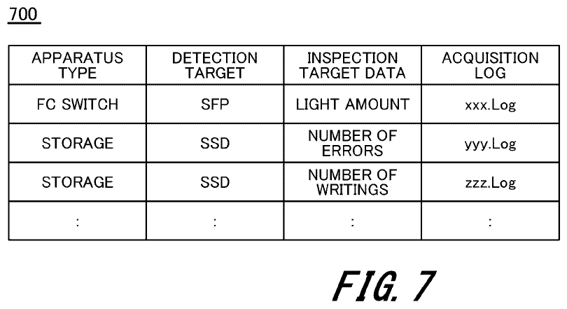

Next, the analysis unit 20 extracts a value (actual numerical value recorded in the operation log 121) corresponding to the inspection target data for each part from the acquired operation log 121 (step S4). As illustrated in FIG. 7 to be described later, the inspection target data corresponds to the inspection target item, and the data used for analysis is different depending on the part (device) to be inspected.

For example, in the case of a small form-factor pluggable (SFP) module that is one of standards of an optical transceiver for connecting an optical fiber to a communication device, data of a light amount is used. Thus, in the following description, “light amount” is taken as an example of the inspection target data. An SFP module (hereinafter referred to as “SFP”) is an optical transceiver that performs mutual conversion between an electrical signal transmitted and received by a communication device and an optical signal flowing through an optical fiber cable.

Next, the analysis unit 20 identifies a hardware location corresponding to the extracted inspection target data from FIG. 5 described later (step S5).

Next, the analysis unit 20 extracts a threshold for the inspection target data from the combination of the redundancy and the business importance level (FIG. 8) (step S6). The threshold is a reference value of the failure sign and is used to determine whether to replace the device as an example.

Next, the analysis unit 20 determines whether the value of the inspection target data extracted from the operation log 121 has exceeded a threshold (step S7). The value of the inspection target data of the operation log is compared with the threshold that is a reference value of the failure sign of SFP, and a replacement part is identified. When the value of the inspection target data has not exceeded the threshold (NO in step S7), the analysis unit 20 proceeds to the determination processing in step S9.

When the value of the inspection target data extracted from the operation log 121 has exceeded the threshold (YES in step S7) in step S7, the analysis unit 20 proceeds to the determination processing in step S8.

In the case of YES determination in step S7, the analysis unit 20 identifies the device for which the value of the inspection target data has exceeded the threshold as a device requiring replacement (step S8).

Next, in the case of NO determination in step S7 or after the processing in step S8, the analysis unit 20 determines whether the inspection of all the inspection target data has been completed (step S9).

In the case of NO determination in step S9, the analysis unit 20 proceeds to step S5, specifies the next hardware location corresponding to the extracted inspection target data, and repeats the subsequent processing.

On the other hand, in the case of YES determination in step S9, the analysis unit 20 proceeds to step S2, acquires a combination of the redundancy and the business importance level of each device again at the time of the next regular inspection, and performs the inspection from the acquisition of the operation log 121 in step S3.

Why the combination of the redundancy and the business importance level of each device is acquired again at the time of the next inspection is because there is a possibility that the state of each device at the time of the current inspection is different from that at the time of the next inspection. When the state of the device, that is, the value of the inspection target data of the operation log, is different, it may be necessary to change the threshold, and the result of comparing the value of the inspection target data with the threshold may also be different. The preventive maintenance support in the present embodiment is an operation in which the maintenance target device is periodically inspected monthly or weekly.

While the monitoring target apparatus 11 is operating, the analysis unit 20 repeatedly executes the processing of steps S2 to S9 to determine the device to be subjected to preventive maintenance.

The analysis unit 20 notifies the operation terminal 30 of information indicating the device determined as needed to be replaced in step S9. At this time, the analysis unit 20 creates the graph 210 for the log of the device with the graph creation unit 21 and calculates the maintenance cost 220 for maintenance (for example, replacement) of the device with the cost estimation unit 22. Then, the analysis unit 20 notifies the operation terminal 30 of the graph 210 and the maintenance cost 220.

A system operator 480 checks the contents displayed on the operation terminal 30 and dispatches a worker to a site where the monitoring target apparatus 11 having the device to be replaced is present to replace the device, or makes a plan of replacement work for the device.

The target of the preventive maintenance is a device that can still continue to operate. Thus, immediacy is not strongly required for performing maintenance and replacement. How to define the operation of preventive maintenance is up to the customer. For example, it is conceivable to perform an operation such as immediately replacing the corresponding devices or collectively replacing the corresponding device for one week on a specific day of the week every week.

The operational effect of the configuration of the preventive maintenance support system 1 according to the present embodiment is that data analysis can be performed from an operation log, which cannot be realized with a public cloud, and it can be said that this is an advantage unique to a private cloud or an on-premises cloud.

### [Specific Example of Internal Structure of Monitoring Target Apparatus]

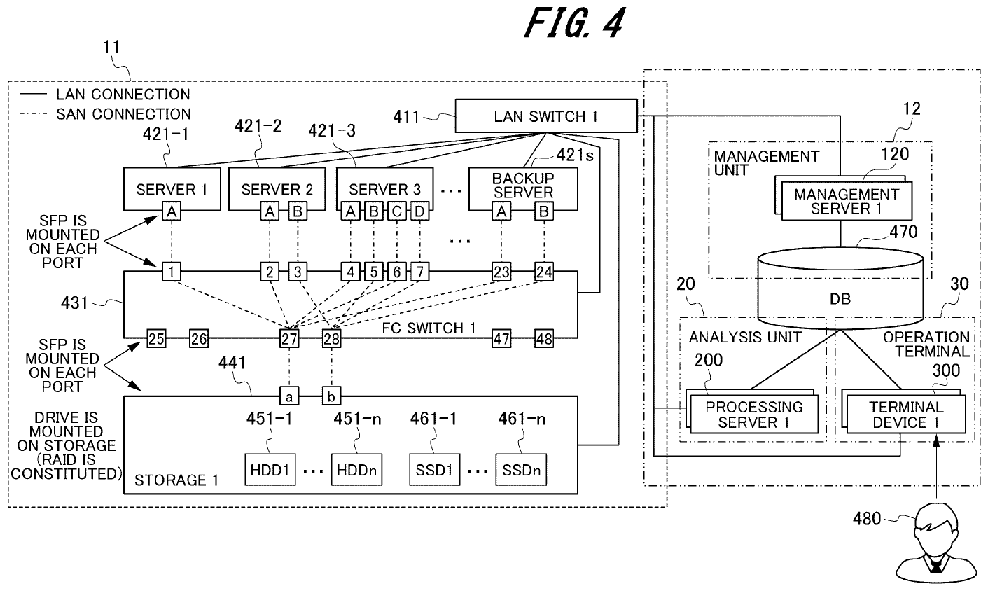

Next, a specific example of an internal structure of the monitoring target apparatus 11 will be described with reference to FIG. 4.

FIG. 4 is a diagram illustrating an example of a hardware configuration of the monitoring target apparatus 11.

The monitoring target apparatus 11 includes typical hardware constituting an IT system, such as a server, a fiber channel (FC) switch, a storage, and a local area network (LAN) switch. For example, FIG. 4 illustrates an example of a LAN switch 411, a plurality of servers 421-1, 421-2, 421-3, . . . , and 421-n (not illustrated), a backup server 421s, a FC switch 431, and a storage 441 as devices that are targets of failure sign detection on the monitoring target apparatus 11. The storage 441 includes HDDs 451-1 to 451-n and SSDs 461-1 to 461-n as drives. The HDDs 451-1 to 451-n and the SSDs 461-1 to 461-n constitute redundant arrays of inexpensive disks (RAID).

Each of the plurality of servers 421-1 to 421-n, the backup server 421s, the FC switch 431, and the storage 441 has an SFP mounted in each port.

LAN connection is established between the LAN switch 411, and the plurality of servers 421-1 to 421-n and the backup server 421s. LAN connection is established also between the LAN switch 411, and the FC switch 431 and the storage 441.

Storage area network (SAN) connection is established between the plurality of servers 421-1 to 421-n and the backup server 421s, and the FC switch 431. Further, SAN connection is established between the FC switch 431 and the storage 441.

In FIG. 4, the LAN switch 411 is denoted as “LAN SWITCH 1”, the server 421-n is denoted as “SERVER n”, the FC switch 431 is denoted as “FC SWITCH 1”, the storage 441 is denoted as “STORAGE 1”, the HDD 451-n is denoted as “HDDn”, and the SSD 461-n is denoted as “SSDn”, where n is a natural number.

The management unit 12 includes one or more management servers 120, a database (DB) 470 that manages information, and a path connected to the LAN switch 411 of the monitoring target apparatus 11. The database 470 is a shared database of the management unit 12, the analysis unit 20, and the operation terminal 30. All tables and data described later are collectively managed in the database 470. In the present embodiment, it is assumed that the database 470 is constructed on the management server 120, but the storage location of the database 470 is not limited to this example. Each management server 120 functions as one management unit 12.

In the SFP, it has been known that as the light emitting element which is an internal component deteriorates over time, the communication with the opposing apparatus is interrupted. Since the light emitting element deteriorates in about several years, the SFP is replaced in advance in consideration of the operating status (age deterioration) of a LAN cable using an optical fiber or a device equipped with the SFP.

The analysis unit 20 includes one or more processing servers 200, a path connected the database 470, and a path connected to the LAN switch 411 of the monitoring target apparatus 11.

Each processing server 200 functions as one analysis unit 20.

The operation terminal 30 includes a plurality of terminal devices 300 serving as user interfaces, a path connected to the database 470, and a path connected to the LAN switch 411 of the monitoring target apparatus 11. Each terminal device 300 functions as one operation terminal 30. The system operator 480 operates the terminal device 300 to input a table and data.

As illustrated in FIG. 5 and FIG. 6 to be described later, the configuration information of the monitoring target apparatus 11 manages the configuration of the hardware already introduced into the monitoring target apparatus 11, the associated system name, and the business name on the database. The system operator 480 adds information each time a device is introduced or added.

### [Configuration Information About Redundancy]

Next, configuration information on the redundancy of the devices mounted on the monitoring target apparatus 11 will be described with reference to FIG. 5. Here, the redundancy of the path used for data transmission will be described as an example of the redundancy.

FIG. 5 is a diagram illustrating an example of configuration information regarding path redundancy of the devices mounted on the monitoring target apparatus 11. The example of FIG. 5 illustrates configuration information in a case where the SFP is a failure sign detection target.

A path redundancy table 500 in the drawing indicates configuration information related to the path redundancy of each device mounted on the monitoring target apparatus 11. The path redundancy table 500 includes items of SFP location, path redundancy, and connection server.

The item of the SFP location includes information indicating a location of the SFP mounted on the monitoring target apparatus 11. That is, it is information indicating the position of a failure sign detection target device (such as SFP) mounted on the monitoring target apparatus 11.

The item of the path redundancy includes information indicating a path redundancy of an apparatus (for example, the server) to which an SFP is attached inside the monitoring target apparatus 11. The path redundancy is an example of information indicating the redundancy of the failure sign detection target device. When the device targeted for failure sign detection is a storage drive or a server, the path redundancy can be replaced with a simple redundancy.

The item of the connection server includes information indicating a server in which the SFP is installed.

For example, in FIG. 5, in the record in the first row of the path redundancy table 500, “SERVER 1 PORT A” is stored in the SFP location, “1 PATH” is stored in the path redundancy, and “SERVER 1” is stored in the connection server. In the record in the second row, “SERVER 2 PORT A” is stored in the SFP location, “2 PATHS” is stored in the path redundancy, and “SERVER 2” is stored in the connection server.

[Configuration Information about Business Importance Level]

Next, configuration information on the business importance level of the devices mounted on the monitoring target apparatus 11 will be described with reference to FIG. 6.

FIG. 6 is a diagram illustrating an example of configuration information regarding the business importance level of the devices mounted on the monitoring target apparatus 11. The example of FIG. 6 illustrates, in the same manner as in FIG. 5, configuration information in a case where the SFP is a failure sign detection target.

A business importance level table 600 in the drawing indicates configuration information related to the business importance level of the server to which each device mounted on the monitoring target apparatus 11 is connected. The business importance level table 600 includes items of connection server, usage business, and business importance level.

The item of the connection server includes information indicating a server in which the SFP is installed.

The item of the usage business includes information indicating the name of the business that uses the server described in the item of the connection server.

The item of the business importance level is the importance level of the business described in the item of usage business. That is, the business importance level is the importance level in the business of the server to which the SFP is installed. For example, large, medium, and small are set as the business importance level. When the device targeted for failure sign detection is a storage drive or a server, the business importance level is the business importance level of the device itself (the storage drive or the server) targeted for failure sign detection.

For example, when a failure sign is detected in a plurality of devices, the business importance level serves as reference information for determining the priority of a device to be subjected to preventive replacement when the operator determines the device to be subjected to preventive replacement.

For example, in FIG. 6, in the record in the first row of the business importance level table 600, “SERVER 1” is stored as the connection server, “AAA BUSINESS” is stored as the usage business, and “SMALL” is stored as the business importance level. In the record in the second row, “SERVER 2” is stored in the connection server, “BBB BUSINESS” is stored in the usage business, and “LARGE” is stored in the business importance level.

In this manner, for each SFP mounted on the FC switch, a table defining availability (redundancy) and importance level from server information using a path (FC path) passing through the SFP is prepared in advance on the management server 120.

### [Inspection Target Data]

Next, inspection target data (inspection target item) for each apparatus included in the monitoring target apparatus 11 will be described with reference to FIG. 7.

FIG. 7 is a diagram illustrating an example of inspection target data (inspection target item) for each apparatus included in the monitoring target apparatus 11. This apparatus corresponds to a server or the like to which a device (for example, the SFP) as a sign detection target is attached.

The inspection target data table 700 in the drawing includes items of apparatus type, detection target, inspection target data, and acquisition log.

The item of the apparatus type includes information indicating an apparatus included in the monitoring target apparatus 11. Examples of the apparatus include an FC switch and a storage.

The detection target item includes information indicating a device targeted for failure sign detection. Examples of the device to be detected include an SFP, an SSD, and an HDD.

The item of the inspection target data includes the inspection target data in the device to be inspected. For example, in the case of an SFP, the inspection target data is the light amount. In the case of an SSD, the inspection target data is the number of errors or the number of writings. As the inspection target data, an index capable of estimating a deterioration state of an apparatus or a device due to aging is used.

The item of the acquisition log includes information specifying log information (for example, operation log) from which information of each item of the corresponding record is obtained. The information for specifying log information is a file path indicating a location of the file describing the log information, a URL describing the location of the log information existing on the communication network, or the like.

For example, in FIG. 7, in the record in the first row of the inspection target data table 700, “FC SWITCH” is stored for the apparatus type, “SFP” is stored for the detection target, “LIGHT AMOUNT” for stored in the inspection target data, and “xxx. Log” for stored in the acquisition log. In the record in the second line, “STORAGE” is stored for the apparatus type, “SSD” is stored for the detection target, “NUMBER OF ERRORS” is stored for the inspection target data, and “yyy. Log” is stored for the acquisition log. In the record in the third line, “STORAGE” is stored for the apparatus type, “SSD” is stored for the detection target, “NUMBER OF WRITINGS” is stored for the inspection target data, and “zzz. Log” is stored for the acquisition log.

### [Threshold for Failure Sign Detection]

Next, a threshold used for failure sign detection on the monitoring target apparatus 11 will be described with reference to FIG. 8. The threshold used for the failure sign detection is a reference value for preventive replacement.

FIG. 8 is a diagram illustrating a setting example of the threshold used for failure sign detection on the monitoring target apparatus 11.

A threshold table 800 illustrated in FIG. 8 illustrates a list of thresholds defined by a combination of the redundancy of the device (here, the path redundancy) and the business importance level.

When the monitoring target apparatus 11 is introduced into the IT system 10, the system operator 480 stores threshold information for the target device with the operation terminal 30. In addition, it is assumed that the system operator 480 is permitted to periodically review the threshold corresponding to age deterioration. For example, when it is necessary to consider the age deterioration of hardware because of characteristics of the target device, the threshold is periodically reviewed.

### (Path Redundancy)

In the threshold table 800, a threshold is stored for each combination of the path redundancy and the business importance level.

The redundancy is based on the concepts of “no redundancy”, “duplexing”, and “multiplexing (more than or equal to triple)”.

No redundancy is a single point of failure. When there is no redundancy, failure itself is not acceptable. Thus, it is necessary to prevent a failure by detecting a sign with a strict threshold.

In the case of duplication, there is no problem with a loose threshold compared to no redundancy. This is because the influence degree at the time of the one-path failure decreases as the multiplexing and the redundancy increase.

In the threshold table 800, “1 path”, “2 paths”, and “4 paths” are illustrated as examples of the path redundancy. In the case of two paths, the performance of the apparatus decreases by 50% with the occurrence of a failure in one path. In the case of four paths, the performance of the apparatus decreases by 25% with the occurrence of a failure in three paths.

### (Business Importance Level)

The business importance level is defined from the availability required for the business and the like.

In one example, a definition based on an operating rate of an apparatus (a server or the like) to which the device as a failure sign detection target is connected (Large: 99.9999%, Medium: 99.99%, Small: 99%), a definition based on a classification of business (Large: accounting system, Small: information system), or the like can be considered. The accounting system corresponds to, for example, transaction business such as deposit and withdrawal in an account of a financial system and remittance between accounts. The information system corresponds to, for example, business such as management of account information of a financial system, which is only affected in a specific financial institution.

In FIG. 8, for example when the path redundancy is “1 PATH”, the threshold is set to “−a dBm or less” when the business importance level is “LARGE”, the threshold is set to “−d dBm or less” when the business importance level is “MEDIUM”, and the threshold is set to “−g dBm or less” when the business importance level is “SMALL”. For example when the path redundancy is “2 PATHS”, the threshold is set to “−b dBm or less” when the business importance level is “LARGE”, the threshold is set to “−e dBm or less” when the business importance level is “MEDIUM”, and the threshold is set to “−h dBm or less” when the business importance level is “SMALL”. Here, a<d<g and b<e<h are satisfied.

In this manner, the business importance level is information indicating relative positioning in the monitoring target apparatus 11 with respect to the device as the failure sign detection target. Instead of uniformly evaluating all the devices in the monitoring target apparatus 11, weighting is performed according to the business importance level, and the effect such as cost performance improvement is expected by changing the maintenance support of the devices. For example, when a device having a small influence at the time of failure is subjected to careful support, cost effectiveness is reduced, but such an inconvenient situation can be prevented by weighting.

### [Concept of Threshold]

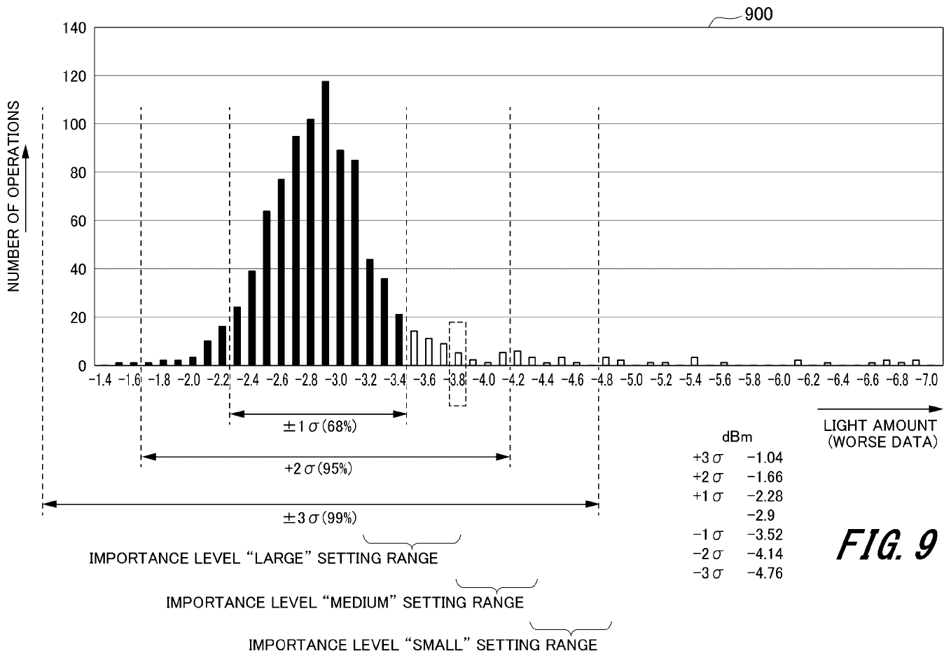

Further, the concept of the threshold in the preventive maintenance support system 1 will be described with reference to FIG. 9 using the light amount threshold of the SFP as an example.

FIG. 9 is a diagram illustrating a concept of a light amount threshold of SFP in the preventive maintenance support system 1. In the illustrated graph 900, the horizontal axis represents the light amount [dbm], the vertical axis represents the number of operating SFPs, and σ represents a standard deviation.

The distribution of the light amount and the number of operating SFPs is generally Gaussian distribution. In a normal SFP, the light amount is distributed around-3 dBm. About 68% of SFP is included in the range of +10 around-3 dBm. About 95% of SFP is included in the range of +20 and about 99% of SFP is included in the range of +30 around-3 dBm. When the light amount exceeds about-5 dBm, the probability of failure of the SFP increases. Thus, as an example, −a dBm to −i dBm of the threshold table 800 may be set in the range of −3 dBm to −5 dBm. Among them, the threshold “+1σ±α” is set when the business importance level is “Large”, the threshold “+2σ±α” is set when the business importance level is “Medium”, and the threshold “+3σ±α” is set when the business importance level is “Small”. α will be described later.

When the threshold of the light amount is too high, the number of SFPs to be replaced increases (SFPs that can still operate normally are also to be replaced). Thus, it is desirable to determine the replacement threshold in consideration of the balance between the cost to be generated and the influence at the time of failure. As an example, the setting range is periodically slid to a strict threshold in accordance with the introduction time (age deterioration) of the monitoring target apparatus 11. This makes it possible to prevent a failure of the important IT system (monitoring target apparatus 11) in advance while reducing the cost.

In the setting of the threshold of the light amount, the threshold may be determined using the standard deviation σ as it is. Alternatively, instead of using the value of the standard deviation σ itself, values before and after the standard deviation σ may be used with a width. As the light amount approaches the mode value, the number of SFPs to be replaced increases (cost increases). Depending on the budget amount of the customer, there is a case where it is not possible to make an investment in part replacement to that extent, and thus it is preferable that the threshold can be adjusted within a range of a certain width. For example, when the budget is exceeded, it is also possible to suppress the cost by setting the threshold to a loose value.

Since the light amount of the SFP having a short remaining life gradually deteriorates, the SFP can be included in the object to be replaced without changing the threshold. However, the number of failures is expected to increase because of age deterioration. On the other hand, by widening the range of the failure sign in the failure sign detection (setting the threshold to a stricter value), it is possible to take a dynamic measure such as preventive replacement before an actual failure occurs.

For example, even within the same small importance level (±30σrange, the left side of FIG. 9 is a stricter sliding direction. Thus, it is conceivable to set the xx value to the left side in the importance level “Small” setting range.

### [Registration of Table]

The registration of each table illustrated in FIGS. 5 to 7 in the database 470 can be an operation to be registered by the system operator 480.

When the IT system 10 including the monitoring target apparatus 11 is introduced, a hardware configuration of the monitoring target apparatus 11, a business using (assigned to) the device and the apparatus, and a part of the sign detection target are selected. The system operator 480 inputs the system configuration information to the database 470 by operating the operation terminal 30 (terminal device 300).

For example, the configuration information obtained through the device purchase process is registered for the path redundancy table 500 of FIG. 5 and the business importance level table 600 of FIG. 6.

In the inspection target data table 700 illustrated in FIG. 7, a part for which a failure sign detection technology is established and a part for which sign detection is desired to be performed are registered.

As for the threshold of the threshold table 800 illustrated in FIG. 8, an initial threshold is set at the start of failure sign detection, and operation is started. When the threshold is adjusted because of age deterioration, the threshold can be updated as needed by the system operator 480.

### [Calculation of Cost]

The cost required for preventive maintenance when a certain threshold is adopted can be calculated as in the following Formula (1). Providing the cost required for preventive maintenance to the customer makes it possible for the customer himself/herself to consider whether the cost has reasonable profitability in accordance with the convenience (budget) of the customer.

$$A = B ⋆ C ⋆ ( D + E ) \qquad ( 1 )$$

A: Total expected cost
B: Total number of ports to be monitored
C: Distribution probability based on the threshold

As an example, when the threshold is-3.8 dBm, about 0.5% of all ports are applicable.
D: Cost for procuring replacement parts
E: Cost for replacement work

The budget to be allocated to the preventive maintenance varies depending on how much sales and cost (accumulation of normal maintenance cost, operation man-hours, and the like) is spent on the apparatus (for example, the server 2 in FIG. 6) equipped with the device targeted for sign detection, the monitoring target apparatus 11, and the like. The budget for preventative maintenance is up to the customer.

### [Example of Failure Sign Detection]

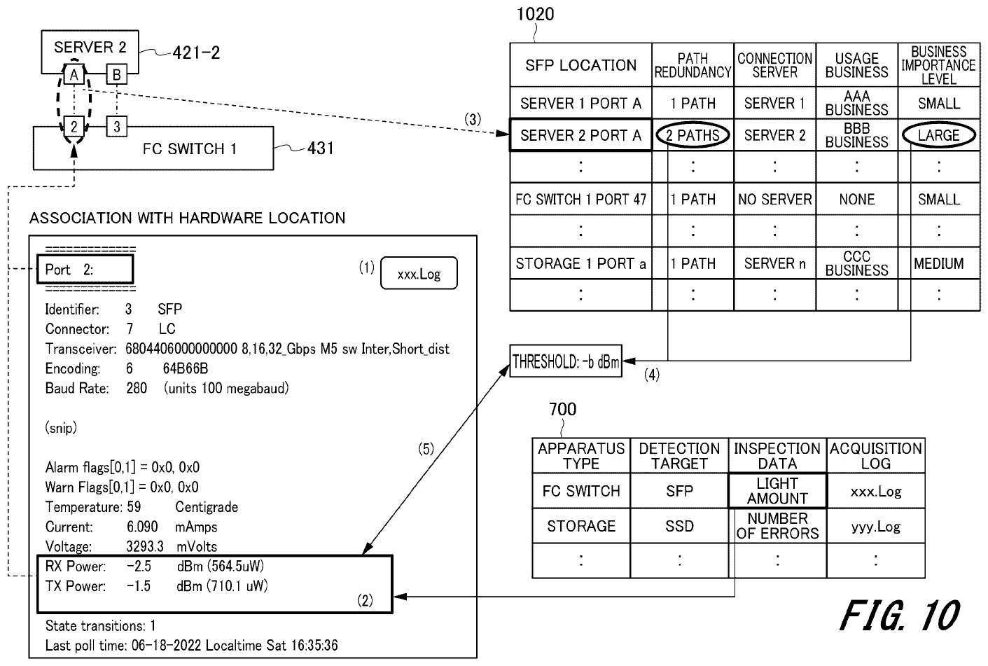

FIG. 10 is a diagram illustrating an example of a failure sign detection with the preventive maintenance support system 1. The failure sign detection and the identification of the replacement target device will be described using the server 421-2 (SERVER 2, FIG. 4) as an example.

For example, in the monitoring target apparatus 11 including the servers 1 to 3, the backup server, the FC switch 1, the storage 1, the SFPs mounted on these external ports, and the FC cable connecting the SFPs, illustrated in FIG. 4, log information of the FC switch 1 is periodically acquired to detect a hardware failure sign.

When light passes through the FC cable, communication between devices (SFP) is performed. Thus, when the intensity of light is weakened, a problem occurs in mutual communication. Since the light emitting element of the SFP deteriorates over time, the light emission amount gradually decreases as the operation is continued. Thus, in the preventive maintenance based on failure sign detection according to the present embodiment, the preventive replacement is performed before the communication completely fails with the light amount as a threshold.

First, the analysis unit 20 acquires log information “xxx. Log” of the detection target device of the monitoring target apparatus 11 in operation from the management unit 12 (processing (1): corresponding to step S3).

Next, the analysis unit 20 extracts a value (actual numerical value recorded in the log information) corresponding to the inspection target data for each part from the acquired log information “xxx. Log” (processing (2), corresponding to step S4).

In this example, the light amount (RX: light reception, TX: light emission) of the port A of the server 2 connected to the port 2 can be known from the information of the port 2 of the FC switch 1 described in the log information “xxx. Log”. In the example of FIG. 10, the amount of received light is described as “−2.5 dBm (564.5 μw)”.

Next, the analysis unit 20 identifies a hardware location corresponding to the extracted inspection target data (light amount) from FIG. 5 (processing (3), corresponding to step S5).

For example, the analysis unit 20 specifies the server 2 port A. A table 1020 illustrated in FIG. 10 is a table obtained by combining the path redundancy table 500 and the business importance level table 600 in FIG. 5.

Next, the analysis unit 20 extracts a threshold (−b dBm in the drawing) for the inspection target data with reference to the threshold table 800 in FIG. 8 from the combination of the path redundancy and the business importance level (processing (4), corresponding to step S6).

In this example, the analysis unit 20 can calculate the standard deviation σ by adding up the light amounts of the SFP mounted on the FC switch 1 and the opposing SFP of the connection destination server 2 from the acquired log information “xxx. Log”. Then, the analysis unit 20 determines, from the calculated standard deviation σ, a reference value (threshold) of a failure sign of the SFP for each business importance level (for example, Large) and path redundancy (for example, two paths) of the apparatus (here, the server 2) equipped with the SPF that is the detection target device.

Next, the analysis unit 20 compares the light amount information of the SFP periodically acquired with the reference value determined for each of the business importance level and the path redundancy of the apparatus (here, the server 2) in which the detection target device is mounted (processing (5), corresponding to step S7). Then, the analysis unit 20 sets the SFP in which the light amount is equal to or less than the reference value as a preventive replacement target.

For example, when the value of RX Power is a value worse than the threshold, the replacement target is identified as the SFP of the port A of the server 2.

As described above, the preventive maintenance support system (preventive maintenance support system 1) according to the present embodiment is a preventive maintenance support system in which a calculator (the calculator 40) including an arithmetic apparatus (the CPU 41, the analysis unit 20) that executes a program and a storage device (the ROM 42 or the non-volatile storage 46) that stores the program executes processing of supporting preventive maintenance on a monitoring target apparatus (the monitoring target apparatus 11).

The arithmetic apparatus is configured to acquire log information (for example, the operation log 121) of a device (for example, SPF) mounted on the monitoring target apparatus, identify a device to be subjected to preventive replacement based on information (for example, light amount) indicating a state of the device included in the log information and a reference value (threshold) of a failure sign determined according to the redundancy (for example, path redundancy) of the device and the importance level (for example, business importance level) of the device, and present the identified device to the operation terminal (the operation terminal 30).

In the preventive maintenance support system having the above configuration, the arithmetic apparatus (analysis unit 20) identifies the device to be subjected to the preventive replacement using the reference value of the failure sign determined according to the redundancy of the device and the importance level of the device, and presents the device to the operation terminal. Then, the system operator 480 determines the preventive maintenance after checking the content presented to the operation terminal. Thus, it is possible to optimize the cost performance at the time of performing the preventive maintenance.

### Specific Example

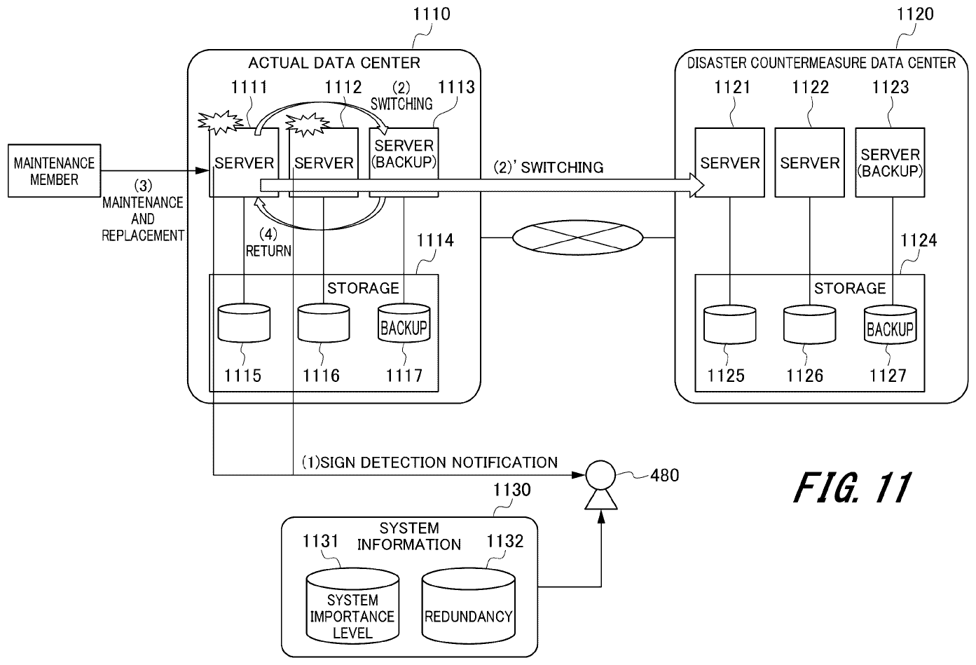

Next, a specific example of the IT system to which the preventive maintenance support system 1 is applied will be described with reference to FIG. 11.

FIG. 11 is a diagram illustrating a specific example of the IT system to which the preventive maintenance support system 1 is applied.

This example is an example of a case where the failure sign detection target device is not an SFP but a server.

The number of errors and the number of writings can be used as the inspection target data of the server. In addition, other error information output by the server or data indicating a slight abnormality with which the server can be operated may be used. Alternatively, from the viewpoint of failure sign detection, the total operating time from the time of introduction of the server may be used as the inspection target data.

In FIG. 11, the IT system includes an actual data center 1110 and a disaster countermeasure data center 1120. When a failure has occurred in the actual data center 1110, switching to the disaster countermeasure data center 1120 is performed. In FIG. 11, the management unit 12 and the analysis unit 20 in FIG. 4 are not illustrated.

The actual data center 1110 includes two servers 1111 and 1112, a backup server 1113, and a storage 1114. The storage 1114 includes HDDs 1115 and 1116 and a backup HDD 1117.

The disaster countermeasure data center 1120 includes two servers 1121 and 1122, a backup server 1123, and a storage 1124. The storage 1124 includes HDDs 1125 and 1126 and a backup HDD 1127.

The analysis unit 20 periodically acquires the log information of each server and the HDD of each storage from the actual data center 1110.

The analysis unit 20 refers to system information 1130 including a system importance level 1131 and a redundancy 1132. The system importance level 1131 corresponds to information of the business importance level in the business importance level table 600 illustrated in FIG. 6. The redundancy 1132 corresponds to information of the path redundancy in the path redundancy table 500 illustrated in FIG. 7.

Here, when a failure sign is detected for the server 1111 or 1112 as failure sign detection targets, the analysis unit 20 notifies the system operator 480 (the operation terminal 30) of the detected failure sign (processing (1)).

For example, the analysis unit 20 notifies the system operator 480 of an appropriate measure defined in advance by the suspicious part (the device as the failure sign detection target) as the system information 1130.

The system operator 480 determines a measure such as switching within the actual data center 1110, switching to the disaster countermeasure data center 1120, or waiting and seeing the situation, based on the redundancy and the importance level of the apparatus such as a server.

For example, in the actual data center 1110, the server 1111 or 1112 can be switched to the backup server 1113 (processing (2)). Alternatively, the data center can be switched by stopping the actual data center 1110 and operating the disaster countermeasure data center 1120 (processing (2)′). After confirming the failure sign detection, the system operator 480 can arrange a maintenance member of the suspected part for preventive replacement (processing (3)). Then, after the preventive replacement of the maintenance member, the system operator 480 can restart the operation of the server 1111 or 1112 of the actual data center 1110 to switch from the backup server 1113 or return the operation subject to the actual data center 1110 (processing (4)).

In the present embodiment, a system with low importance level is calmly observed without performing preventive maintenance, and a system with real importance level is switched to the system for disaster countermeasures, for example. Thus, the response is changed depending on the redundancy and importance level of the apparatus. This can optimize the total cost required for the entire preventive maintenance.

Basically, the system operator 480 checks information (redundancy, importance level) provided from the analysis unit 20 and displayed on the operation terminal 30, and determines the measure. The analysis unit 20 may be configured to suggest a measure to the customer through the operation terminal 30 in association with the threshold table and the switching measure content.

When confirming a plurality of failure sign detections, the system operator 480 can check the system information 1130 (system importance level, redundancy) displayed on the operation terminal 30 and determine the priority.

The present invention is not limited to the above-described embodiment, and it is needless to say that various other modifications and application examples can be taken without departing from the gist of the present invention described in the claims. The configuration of the embodiment described above has been described in detail to clearly describe the present invention, and is not necessarily limited to those having all the described components. It is possible to add, replace, and delete other components for a part of the configuration of each embodiment.

Some or all of the above-described configurations, functions, processing units, and the like may be realized by hardware, for example, by designing with an integrated circuit. A processor device in a broad sense such as a field programmable gate array (FPGA) or an application specific integrated circuit (ASIC) may be used as the hardware.

Each component of the preventive maintenance support system according to the above-described embodiment may be implemented in any hardware as long as the hardware can transmit and receive information to and from each other via a network. The processing performed by a certain processing unit may be realized by one piece of hardware or may be realized by distributed processing with a plurality of pieces of hardware.

In the above-described embodiment, control lines and information lines considered to be necessary for description are illustrated, and not all control lines and information lines are necessarily illustrated in terms of products. In practice, it may be considered that almost all the components are connected to each other.

In the present specification, the processing steps describing time-series processing include not only processing performed in time series according to the described order, but also processing that is not necessarily performed in time series but is executed in parallel or individually (for example, processing by an object). The processing order of the processing steps describing time-series processing may be changed within a range not affecting the processing result.

What is claimed is:

1. A preventive maintenance support system in which a calculator including an arithmetic apparatus that executes a program and a storage device that stores the program executes processing of supporting preventive maintenance on a monitoring target apparatus, wherein
the arithmetic apparatus acquires log information of a device mounted on the monitoring target apparatus, identifies a device to be subjected to preventive replacement based on information indicating a state of the device included in the log information and a reference value of a failure sign determined according to a redundancy of the device and an importance level of the device, and presents the device to an operation terminal.

2. The preventive maintenance support system according to claim 1, wherein
the importance level of the device is an importance level in business of an apparatus to which the device is attached inside the monitoring target apparatus, or an importance level of the device itself.

3. The preventive maintenance support system according to claim 2, wherein
the arithmetic apparatus calculates in advance a cost at a time of performing preventive replacement of the device to be subjected to the preventive replacement, and presents the cost to the operation terminal.

4. The preventive maintenance support system according to claim 1, wherein
the device mounted on the monitoring target apparatus is an optical transceiver that performs mutual conversion between an electrical signal transmitted and received by a communication device and an optical signal flowing through a cable, and
the information indicating the state of the device is a light amount of light output from the optical transceiver.

5. The preventive maintenance support system according to claim 1, wherein
the device mounted on the monitoring target apparatus is a drive of a storage, and
the information indicating the state of the device is the number of errors or the number of writings of the drive.

6. A preventive maintenance support method for causing a calculator including an arithmetic apparatus that executes a program and a storage device that stores the program to execute processing of supporting preventive maintenance on a monitoring target apparatus, the method comprising:
processing of causing the arithmetic apparatus to acquire log information of a device mounted on the monitoring target apparatus;
processing of causing the arithmetic apparatus to identify a device to be subjected to preventive replacement based on information indicating a state of the device included in the log information and a reference value of a failure sign determined according to a redundancy of the device and an importance level of the device; and
processing of causing the arithmetic apparatus to present the device to be subjected to the preventive replacement to an operation terminal.
